(19) United States
(12) Patent Application Publication
(10) Pub. No.: US 2015/0217263 A1
(43) Pub. Date: Aug. 6, 2015

(54) METHOD OF SIMULTANEOUS CAVITATION TREATMENT OF LIQUID MEDIA DIFFERENT IN COMPOSITION

(71) Applicant: Cavitanica Ltd., Kazan (RU)

(72) Inventors: Andrej Getalov, Moscow (RU); Evgeny Dedyukhin, Kazan (RU); Marat Giniyatullin, Kazan (RU); Aleksandr Sirotkin, Kazan (RU)

(21) Appl. No.: 14/454,127

(22) Filed: Aug. 7, 2014

Related U.S. Application Data
(63) Continuation of application No. PCT/RU2012/000421, filed on May 28, 2012.

(30) Foreign Application Priority Data
Mar. 26, 2012 (RU) 2012111141

(51) Int. Cl. B01J 19/10; B01F 11/02; B01F 3/08

(52) U.S. Cl. CPC B01J 19/10; B01F 3/0811; B01F 11/02; B01J 2219/0877

(57) ABSTRACT

The present invention relates to a method of simultaneous cavitation treatment of liquid media having different compositions. The acoustic cavitation may operate by a double resonance effect inside a flow mechanical oscillatory system—formed as a rectangular channel of finite length. At opposing sides of which, the channel side walls generate in-phase sound oscillations. The interior of the mechanical oscillatory system rectangular channel further has additional flow channels therein to supply treated liquid media, the specific acoustic resistance of material of additional flow channels is close to the acoustic resistance of operating liquid. The width of the channel interior h is a multiple of a quarter of wavelength for the operating liquid at the frequency equal to the basic frequency of system-channel. The amplitude of system-channel wall oscillations creates a fully-developed acoustic cavitation mode over the entire inner volume of operating liquid including the flow channels liquid media therein.

### PRIORITY CLAIM

This application is a continuation utility patent application which claims the benefit to and priority from International Patent Application number PCT/RU2012/000421 filed on May 28, 2012, which in turn claims priority to Russian Patent Application number RU2012/111141 filed on Mar. 26, 2012.

### FIELD OF INVENTION

This invention relates to the cavitation treatment of liquid media and media where specific content of water or other liquid phase is more than ˜35-40% of the total mass.

### DESCRIPTION OF RELATED ART

Acoustic ultrasonic cavitation is known to be efficiently used in different fields to implement the following processes:
Dispersion;
Homogenization and emulsification;
Blending;
Disintegration;
Deagglomeration

In actual practice this relates to production processes of multicomponent media (emulsions, suspensions, aqueous solutions and systems), ultrasonic sterilization (disinfection) of water, milk, other food products, cleaning of tools and medical appliances, etc.

The method of liquid media treatment implemented in ultrasonic reactors configuration can be taken as prior art. These methods create, in a volume of liquid, an ultrasonic wave by a rod radiator equipped at its end with a source of ultrasonic oscillations, generally a piezoelectric radiator.

There are numerous variants to calculate the shape of the rod radiator and feasibility of mounting several piezoradiators on its end, however, all of them are designed to increase the amplitude of rod oscillations at its lower end and side walls.

This is because in actual practice the fully-developed cavitation zone is sized in several centimeters from the oscillation surface. Therefore, the bottom part of the rod is considered the most efficient zone, because between the flat end of the radiator and the flat bottom in the treated liquid there forms a standing wave. It is difficult to make the diameter of the bottom part of the end more than 50-70 mm. There are restrictions on the volume of treated medium and on simultaneous treatment by one reactor of two or more liquid media of different composition without their blending.

Another alternative method of ultrasonic cavitation treatment of liquid media has been implemented in rotary-pulsed homogenizers.

In the ultrasonication chamber, cyclic alternating movements of the liquid from the stator-rotor system forms an ultrasonic wave with cavitation effects. This is an intermediate version between the acoustic and hydrodynamic cavitation. Currently these homogenizers are most common. They are fairly simple, substantially cheaper than the ultrasonic analogues and allow treating large volumes of liquids.

However, there are fundamental restrictions for this method, too.

Low efficiency of electromechanical systems (up to 10%) limits the power of ultrasonic wave to 2-3 W/cm2 which is not sufficient for many processes, e.g. for destruction of paraffin oil or for destruction of sand-concrete mixture. The rotary-pulsed homogenizers are constrained in viscosity of the treated liquid, specifically, when suspension contains solids sizing more than ˜0.5 mm.

Simultaneous homogenization of different media compositions is also impossible.

Another prior art is the method of producing emulsified cosmetic preparation according to U.S. Pat. No. 2,427,362 of Aug. 9, 2010. In this method, the acoustic cavitation mode forms by double resonance effect inside the flow mechanical oscillatory system—a rectangular channel of finite length at the opposite sides of which acoustic oscillations are generated in-phase to form a standing wave at the basic frequency for this channel wall which, in their turn form in the area between the channel walls a quasi-plane standing wave in the moving multiphase medium, the width of the channel wall h is, at that, multiple of a quarter of length of the wave excited in this multiphase medium, and the channel wall amplitude is optimum for different stages of emulsion production and exceeds the acoustic cavitation threshold for this treated moving multiphase medium.

Successive resonance enhancements of acoustic oscillation amplitude forming in the liquid treated medium allowed to create energy deposition up to ˜100 W/cm², concentrated in the narrow range close to the resonance frequency ˜+−1-2 kHz.

One disadvantage of this method the incapacity of the flow-type reactor to simultaneously treat different media without blending, among others.

### SUMMARY

The purpose of the invention is the possibility of simultaneous cavitation treatment of liquid media different in composition without blending in one flow-type reactor.

This purpose is achieved by having in the clearance of the mechanical oscillatory system-rectangular channel with liquid medium additional flow channels to supply the treated liquid media, specific acoustic resistance of the material of additional flow channels being close to the acoustic resistance of operating liquid, the width of the area within the rectangular channel h being a multiple of quarter of length of the wave for the operating liquid at the frequency equal to the basic frequency of the system-channel wall, and the system-channel wall oscillation amplitude forming the fully developed acoustic cavitation mode over the entire inner volume of the operating liquid with flow channels placed in the liquid media.

By this method single flow-type reactor can treat different media without blending which is convenient in process cycles with simultaneous production of wide choice of products and quick readjustment of production from one product type to another.

### BRIEF DESCRIPTION OF THE DRAWINGS

FIG. 1 provides a cross sectional view of an embodiment of the system of the present invention.

FIG. 2 provides a perspective view of an embodiment of the present invention.

FIG. 3 provides an oscillation spectrogram of an embodiment of wall oscillation during operation.

### DETAILED DESCRIPTION

A method of simultaneous cavitation treatment of liquid media different in composition by which the acoustic cavitation is formed by double resonance effect inside a flow mechanical oscillatory system—being a rectangular channel of finite length. Opposing sides of the channel provide sound oscillations generated in-phase, in that the interior of the rectangular channel has additional flow channels to supply liquid media for treatment. The specific acoustic resistance of material of the additional flow channels is close to the acoustic resistance of the operating liquid. The width of the rectangular flow channel h is selected to be a multiple of quarter of wavelength for the operating liquid at the frequency equal to the basic frequency of system-channel wall and the amplitude of system-channel wall oscillations. The system creates fully developed acoustic cavitation over the entire inner volume of operating liquid with flow channels and in the liquid media therein.

The invention relates to cavitation treatment of liquid media and media where specific content of water or other liquid phase is more than ˜35-40% of the total mass. The method is efficient in the following processes: dispersion, homogenization and emulsification, blending, disintegration, deagglomeration.

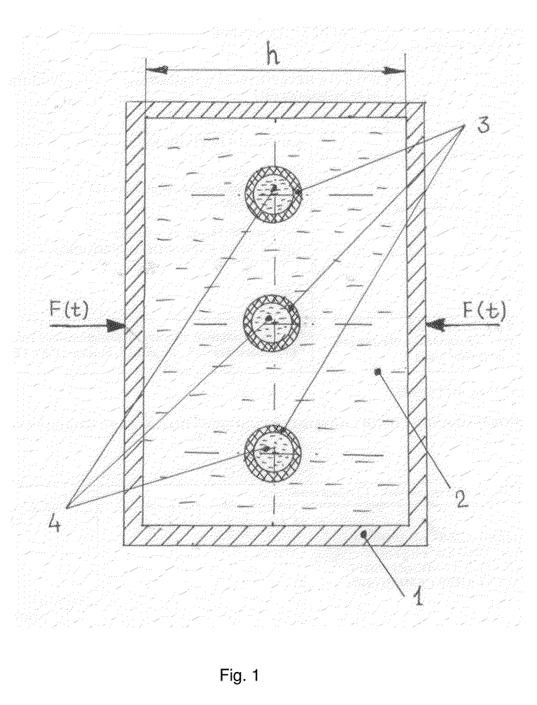

FIG. 1 shows diagrammatic section of an embodiment of a flow-type reactor to implement this method. Channel 1 is filled, at least partially, with operating liquid 2. Flow channels 3 are positioned within the channel 1 and covered by the operating liquid 2, these enclosed channels 3 contain media 4 for ultrasonic cavitation treatment. Side walls, marked as F(t) are configured to provide oscillation, which transfers to the operating liquid 2, the flow channels 3, and eventually the media 4 for treatment. The plurality of flow channels 3 extend through the rectangular flow channel within the operating liquid. Treamend media may be pumped or otherwise moved through the flow channels 3 during treatment. For the operating liquid 2, it is possible to recommend water, its specific acoustic resistance is well known. However, any liquid may be used. For the material of additional flow channels 3, if the operating liquid 2 is water it is possible to recommend polyethylene (density 0.92-0.94 g/cm3, longitudinal wave velocity ˜1900-1950 m/s), which has similar acoustic properties to water. Though, other materials may be used. Thickness of the additional flow channel 3 walls should be minimal to reduce acoustic wave passage loss.

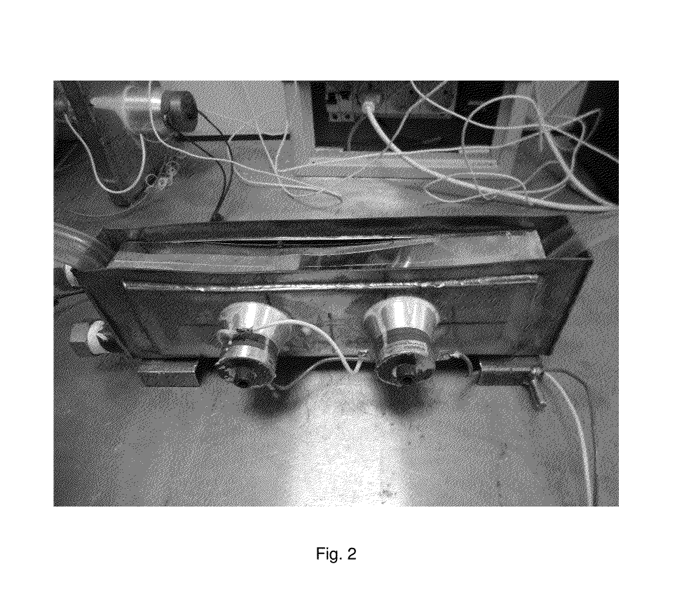

FIG. 2 shows one of the versions to implement this method. The oscillatory system-rectangular channel 1 is made as a bath, the operating liquid 2 is water. Additional flow channels 3 are made of normal polyethylene hose 12 mm in diameter, with walls 1 mm thick.

Pumps to be used are diaphragm, lobe rotary, screw, gear or other—depending on the viscosity and composition of the liquid media to be treated.

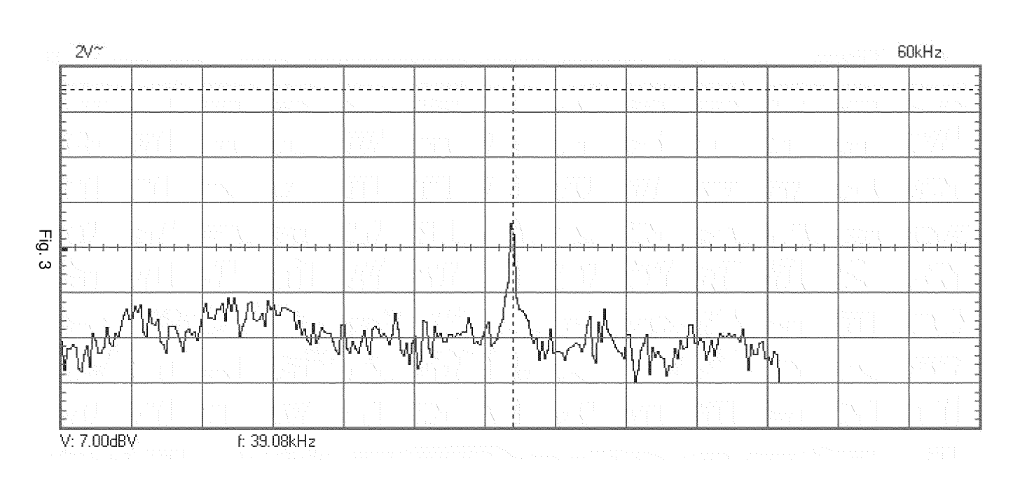

The wall (diaphragm) passing frequency oscillation may be about 40 kHz. The oscillation spectrogram is shown in FIG. 3.

Measurements are made with the measurement section verified by ROSTEST, consisting of 4344-type accelerometer and Bruel&Kjaer 2635 amplifier, Velleman PCSU1000 digital oscilloscope with fast Fourier transform function to record signals with a personal computer. Linear scale with peak resolution 60 kHz is used.

The width h of the channel (bath) 1 in this embodiment is four cm, which is close to the wavelength value in water for this frequency. The operating liquid 2 can be both in the flow mode and in the steady-state mode. The flow mode of the operating liquid 2 is convenient to create required optimum temperature in the channels 1 with treated media 4.

A maximum amplitude of the channel 1 wall oscillations is ˜5-6 microns, this is in agreement with the amplitude of acoustic wave in the operating liquid 2 about 100 W/cm2. This oscillation amplitude creates fully developed cavitation mode in not only the operating liquid 2, but also inside the polyethylene hose (additional flow channel) 3 with the treated medium 4 positioned or flowing there through.

Some examples of the media 4 treated in experiments include cosmetic emulsions, paraffin oil (paraffin content ˜40%) with water (up to 20% by weight), sand-concrete mixtures, toothpaste, shoe polish, alcohol solutions with natural and synthetic oils, milk and other mixtures.

The method contemplated herein for simultaneous cavitation treatment of liquid media different in composition allows the treatment of different media without blending by a single reactor. This approach is a convenient and practical application, e.g. to produce a wide choice of small output products. In other circumstances one reactor with appropriate replacement of additional flow channels makes possible to readjust production from cosmetic preparations to, e.g., food products or toothpaste, or shoe polish, etc. for example, by simply replacing a tubing or similar flow channel. As was shown replacements in the reactors and design of additional flow channels cause no trouble.

1. (canceled)

2. A method of simultaneous ultrasonic cavitation treatment of liquid media having different compositions comprising the steps of:
positioning a plurality of enclosed flow channels within a rectangular channel of a mechanical oscillatory system, opposing sides of the mechanical oscillatory system channel providing sound oscillations generated in-phase, a quantity of treatment fluid being positioned within the rectangular channel and covering the plurality of enclosed flow channels, a width of the rectangular channel selected to be a multiple of a quarter of a wavelength generated in the treatment fluid, the frequency being equal to a basic frequency of the sides of the mechanical oscillatory system;
flowing a first liquid media through one of the plurality of enclosed flow channels;
flowing a second liquid media different from the first liquid media through another of the plurality of enclosed flow channels;
generating oscillations by the rectangular channel walls having an amplitude sufficient to generate acoustic cavitation within the treatment fluid, and the first and second liquid media within the plurality of enclosed flow channels.

3. The method of simultaneous ultrasonic cavitation treatment of liquid media having different compositions of claim 1 wherein the first liquid media and second liquid media each have a liquid phase of more than 35% of the total mass.

4. The method of simultaneous ultrasonic cavitation treatment of liquid media having different compositions of claim 1 wherein the first liquid media and second liquid media each have a liquid phase of more than 40% of the total mass.

5. The method of simultaneous ultrasonic cavitation treatment of liquid media having different compositions of claim 1 wherein the plurality of flow channels are each formed of polyethylene.

6. The method of simultaneous ultrasonic cavitation treatment of liquid media having different compositions of claim 1 wherein the treatment fluid is water.

7. The method of simultaneous ultrasonic cavitation treatment of liquid media having different compositions of claim 6 wherein a material of a wall of the plurality of flow channels is selected to have a similar acoustic property to water.

8. The method of simultaneous ultrasonic cavitation treatment of liquid media having different compositions of claim 5 wherein the flow channel is formed of polyethylene tubing having a diameter of 12 mm and a wall thickness of 1 mm.

9. The method of simultaneous ultrasonic cavitation treatment of liquid media having different compositions of claim 1 wherein the step of flowing the first and second liquid media is performed using a pump, the pump being one of a diaphragm pump, lobe rotary pump, screw pump, or gear pump.

10. The method of simultaneous ultrasonic cavitation treatment of liquid media having different compositions of claim 1 wherein the walls of the rectangular channel are oscillated at approximately 40 kHz.

11. The method of simultaneous ultrasonic cavitation treatment of liquid media having different compositions of claim 10 wherein the width of the rectangular channel is sized to be approximately 4 cm.

12. The method of simultaneous ultrasonic cavitation treatment of liquid media having different compositions of claim 11 wherein an amplitude of the walls of the rectangular channel oscillations are approximately 5-6 microns.

13. The method of simultaneous ultrasonic cavitation treatment of liquid media having different compositions of claim 1 wherein the first liquid media is a cosmetic emulsion.

14. The method of simultaneous ultrasonic cavitation treatment of liquid media having different compositions of claim 1 wherein the first liquid media is a paraffin oil comprising paraffin and water.

15. The method of simultaneous ultrasonic cavitation treatment of liquid media having different compositions of claim 1 wherein the first liquid media is a sand-concrete mixture.

16. The method of simultaneous ultrasonic cavitation treatment of liquid media having different compositions of claim 1 wherein the first liquid media is a toothpaste.

17. The method of simultaneous ultrasonic cavitation treatment of liquid media having different compositions of claim 1 wherein the first liquid media is a shoe polish.

18. The method of simultaneous ultrasonic cavitation treatment of liquid media having different compositions of claim 1 wherein the first liquid media is a milk.

19. The method of simultaneous ultrasonic cavitation treatment of liquid media having different compositions of claim 1 wherein the first liquid media is an alcohol mixture.

20. The method of simultaneous ultrasonic cavitation treatment of liquid media having different compositions of claim 1 further comprising the steps of:
removing the plurality of enclosed flow channels from the rectangular channel;
positioning a second plurality of enclosed flow channels in the rectangular channel;
flowing a first liquid media through one of the second plurality of enclosed flow channels; and
flowing a second liquid media different from the first liquid media through another of the second plurality of enclosed flow channels.
